(19) United States
(12) Patent Application Publication
(10) Pub. No.: US 2011/0074759 A1
(43) Pub. Date: Mar. 31, 2011

(54) PLASMA DISPLAY DEVICE

(76) Inventors: Seung-Hun Chae, Yongin-si (KR); Jae-Won Kim, Yongin-si (KR)

(21) Appl. No.: 12/869,724

(22) Filed: Aug. 26, 2010

(30) Foreign Application Priority Data
Sep. 30, 2009 (KR) 10-2009-0093496

(51) Int. Cl. G09G 5/00; G09G 3/28

(52) U.S. Cl. 345/211; 345/60

(57) ABSTRACT

A plasma display device having a plasma display panel (PDP) including: a plurality of electrodes; a printed circuit board assembly (PBA) to drive the plasma display panel (PDP); and a chassis base including a first surface supporting the plasma display panel (PDP) and a second surface mounted with the printed circuit board assembly (PBA), wherein the PDP includes signal lines and a power line continuously formed on an edge of the PDP, electrode terminals connected to the electrodes the signal lines and the power lines, signal line terminals disposed on one side of the electrode terminals and connected to the signal lines, an alignment mark formed on at least at one side of the signal line terminals, and a power terminal disposed on a side of the alignment mark connected to the power line and supplying power to the PDP.

### CROSS-REFERENCE TO RELATED APPLICATION

This application claims priority to and the benefit of Korean Patent Application No. 10-2009-0093496 filed in the Korean Intellectual Property Office on Sep. 30, 2009, the entire contents of which are incorporated herein by reference.

### BACKGROUND

1. Field

Aspects of the described technology relate generally to a plasma display device reducing impedance of a power line formed in a plasma display panel (PDP) when removing/reducing an address buffer board assembly, and forming a part of constituents generated due to the removing/reducing to the PDP.

2. Description of the Related Art

Generally, a plasma display device includes a plasma display panel (PDP) displaying images, a chassis base supporting the PDP, and a plurality of printed circuit board assemblies (PBAs) installed in the chassis base.

Among the PBAs, the address buffer board assembly is connected to an address electrode, through a flexible printed circuit (FPC) such as a tape carrier package (TCP), to receive a voltage and a control signal from a power supply board assembly and from a logic board assembly, and to apply the voltage and control signal to the address electrodes provided in the PDP.

The power supply board assembly applies an address voltage Va to the address buffer board assembly, the logic board assembly applies a driver IC operation voltage Vcc, a driver IC control signal, a clock signal, and an address data signal to the address buffer board assembly, and the address buffer board assembly controls selected address electrodes according to the signals.

To simplify the components of the plasma display device and to reduce manufacturing cost, it is preferable that the address buffer board assembly be removed or the number of its elements be reduced. Here, the function of the elements which have been removed/reduced, are performed in the plasma display device.

The above information disclosed in this Background section is only for enhancement of understanding of the background of the described technology and therefore it may contain information that does not form the prior art that is already known in this country to a person of ordinary skill in the art.

### SUMMARY

An exemplary embodiment of the present invention relates to a plasma display device having reduced power line impedance formed in a PDP due to the reduction/removal of the address buffer board assembly.

An exemplary embodiment of the present invention relates to a plasma display device reducing impedance by increasing a width of a power terminal connected to a power line.

According to an exemplary embodiment of the present invention, a plasma display device includes: a plasma display panel (PDP) including a plurality of electrodes; a printed circuit board assembly (PBA) to drive the plasma display panel (PDP); and a chassis base including a first surface supporting the plasma display panel (PDP) and a second surface mounted with the printed circuit board assembly (PBA), wherein the PDP includes signal lines and a power line continuously formed on an edge of the PDP, electrode terminals connected to the electrodes, the signal lines and the power line, signal line terminals disposed on one side of the electrode terminals and connected to the signal lines, an alignment mark formed at least at one side of the signal line terminals and the electrode terminals, and a power terminal disposed on a side of the alignment mark connected to the power line and supplying power to the PDP.

The plasma display device according to another exemplary embodiment of the present invention further includes an interface flexible printed circuit (IFPC) having one side connected to the PBA and the other side connected to the signal lines and the power line, and a flexible printed circuit (FPC), having a driver IC mounted thereon, connected to the signal line terminals and the power terminal on one side, and connected to the electrode terminals on another side.

According to another exemplary embodiment of the present invention, the electrode terminals may correspond to the flexible printed circuit (FPC) thereby forming terminal groups, the terminal groups may be disposed in a first direction, and the power terminal may be integrally formed between terminal groups of a neighboring pair.

According to another exemplary embodiment of the present invention, alignment marks may be formed on both sides of each one of the terminal groups.

According to another exemplary embodiment of the present invention, the electrode terminals, the signal line terminals, and the alignment marks may be extended in a second direction intersecting the first direction, and may have the same length along the second direction.

According to another exemplary embodiment of the present invention, the power terminal may be extended longer than the electrode terminals, the signal line terminals, and the alignment marks in the second direction.

According to another exemplary embodiment of the present invention, the power terminal may have a width greater than a width of the electrode terminals, the signal line terminals, and the alignment marks in the first direction.

A plasma display device according to another exemplary embodiment of the present invention includes: a plasma display panel (PDP) including a front substrate, a rear substrate, a plurality of electrodes between the front substrate and the rear substrate, and signal lines, a power line, electrode terminals, signal line terminals, an alignment mark, and a power terminal separated from the plurality of electrodes and formed at the rear substrate; a chassis base close to the rear substrate; and a plurality of printed circuit board assemblies (PBAs) mounted to the chassis base, wherein the signal lines and the power line are continuously formed on an edge of the PDP, the electrode terminals are connected to the electrodes, the signal lines and the power line, the signal line terminals are disposed on one side of the electrode terminals and connected to the signal lines, the alignment mark is formed at least at one side of the signal line terminals and the electrode terminals, and the power terminal is disposed at one side of the alignment mark and connected to the power line and supplying power to the PDP.

According to another exemplary embodiment of the present invention, electrode terminal connected to each flexible printed circuit (FPC) form a terminal group, the terminal group may be disposed according to a first direction, the alignment mark may be formed on the side of the terminal group, and the power terminal may be integrally formed between neighboring alignment marks.

According to another exemplary embodiment of the present invention, the electrode terminals, the signal line terminals and the alignment mark may extend in a second direction intersecting the first direction and having a first length, and the power terminal may have a second length longer than the first length according to the second direction.

According to another exemplary embodiment of the present invention, the electrode terminals and the signal line terminals may have a first width according to the first direction, the alignment mark may have a second width wider than the first width according to the first direction, and the power terminal may have a third width wider than the second width according to the first direction.

According to another exemplary embodiment of the present invention, the power terminal may have a first power terminal connecting an interface flexible printed circuit (IFPC) and a flexible printed circuit (FPC) at both sides.

According to another exemplary embodiment of the present invention, the power terminal may have a second power terminal respectively connecting one pair of flexible printed circuits (FPCs) at both sides in the first direction.

According to an exemplary embodiment of the present invention, the width of the power line formed in the PDP due to the removing/reducing of the address buffer board assembly is increased such that the impedance of the power line is reduced. Also, the width of the power terminal connected to the power line is increased such that the impedance of the power line and the power terminal is reduced.

According to another exemplary embodiment of the present invention, the power terminal connected to the power line is disposed outward of the alignment mark disposed on both sides of the address electrode terminals such that the width of the power terminal may be increased so as to reduce the impedance of the power line and the power terminal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display device according to an exemplary embodiment of the present invention;

FIG. 2 is a cross-sectional view taken along the line II-II of FIG. 1;

FIG. 3 is a perspective view of the PDP shown in FIG. 1 from the front side;

FIG. 4 a top plan view showing signal lines and a power line that are formed on an edge of the PDP of FIG. 3 connected to a flexible printed circuit (FPC) and an interface flexible printed circuit (IFPC);

FIG. 5 is a top plan view showing an arrangement of signal lines, a power line, an alignment mark, and a power terminal, and a connection state of an interface flexible printed circuit (IFPC) of FIG. 4;

FIG. 6 is a top plan view showing an arrangement of signal lines, a power line, electrode terminals, an alignment mark, and a power terminal, and a connection state of an interface flexible printed circuit (IFPC) of FIG. 4; and

FIG. 7 is a rear view of a chassis base of a plasma display device according to the second exemplary embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An aspect of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

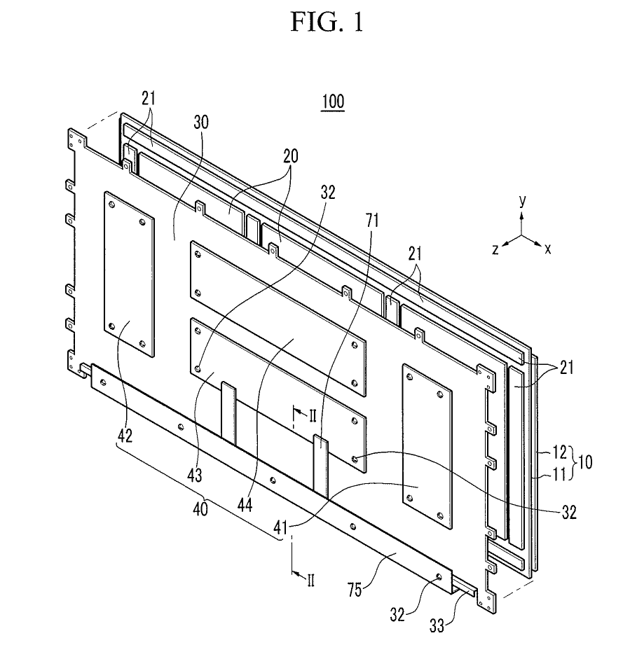

FIG. 1 is an exploded perspective view of a plasma display device according to an exemplary embodiment of the present invention. As shown in FIG. 1, a plasma display device 100 according to this exemplary embodiment includes a plasma display panel (PDP) 10 displaying images by using gas discharge, a heat dissipation sheet 20, a chassis base 30, and a printed circuit board assembly (PBA) 40.

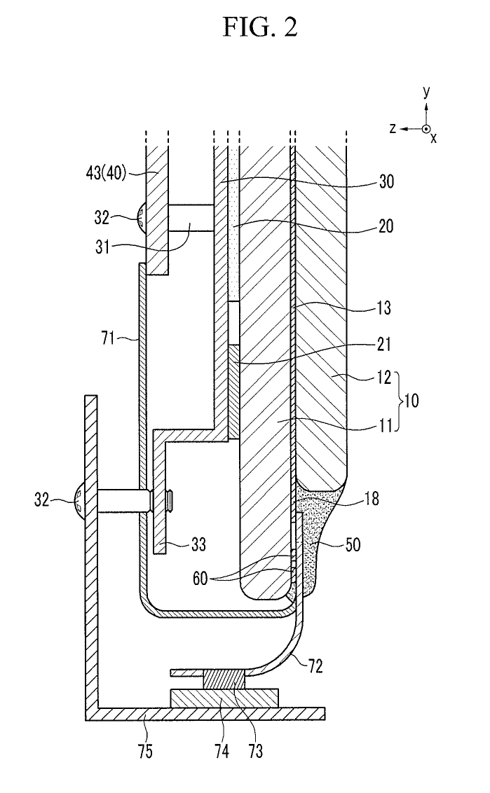

FIG. 2 is a cross-sectional view taken along the line II-II of FIG. 1. As shown in FIG. 2, the PDP 10 includes a rear substrate 11 and a front substrate 12 made of glass, and electrodes generating the gas discharge between the rear substrate 11 and the front substrate 12, such as sustain electrodes (not shown), scan electrodes (not shown), and address electrodes 13.

The heat dissipation sheet 20 is provided between the PDP 10 and the chassis base 30, such that heat generated in the PDP 10 by the gas discharge may be continuously diffused. The chassis base 30 is attached to the rear substrate 11 of the PDP 10 by double-sided adhesive tape 21 via the heat dissipation sheet 20, thereby supporting the PDP 10.

Again referring to FIG. 1, PBAs 40 are formed to drive the PDP 10, and are electrically connected (not shown) to the PDP 10. The PBAs 40 perform their respective functions to drive the PDP 10, and therefore they are scattered along the PDP 10. For example, the PBAs 40 include a sustain board assembly 41, a scanning board assembly 42, an integrated board assembly 43, and a power supply board assembly 44.

The sustain board assembly 41 is connected (not shown) to the sustain electrodes (not shown) by a flexible printed circuit (FPC), thereby controlling the sustain electrodes. The scanning board assembly 42 is connected (not shown) to the scan electrodes (not shown) by the FPC, thereby controlling the scan electrodes. The integrated board assembly 43 receives video signals from the outside of the PDP to generate control signals to drive the address electrodes 13, the sustain electrodes, and the scan electrodes, and selectively applies the control signals to the corresponding board assemblies. The power supply board assembly 44 supplies power to drive the board assemblies.

Differently from the conventional art, in an exemplary embodiment of the present invention, an address buffer board assembly to drive the address electrodes 13 is not separately provided. That is, the PBAs 40 do not include the address buffer board assembly.

Again referring to FIG. 2, the PDP 10 is attached to a first surface of the chassis base 30, that is, the front surface of the chassis base 30 so as to be supported, and the PBAs 40 are mounted at a second surface of the chassis base 30, that is, the rear surface of the chassis base 30. The plurality of PBAs 40 (in FIG. 2, an integrated board assembly 43 is exemplarily shown) are respectively disposed at a plurality of bosses 31 provided at the chassis base 30, and are coupled to the chassis base 30 with setscrews 32 such that they are mounted to the chassis base 30.

As described above, the address buffer board assembly is eliminated from the plasma display 100 such that the elements performing the functions that are generally executed in the address buffer board assembly are performed in the conventional logic board assembly. As a result, the integrated board assembly 43 performs the functions of the address buffer board assembly and the conventional logic board assembly simplifying the structure of the plasma display device 100.

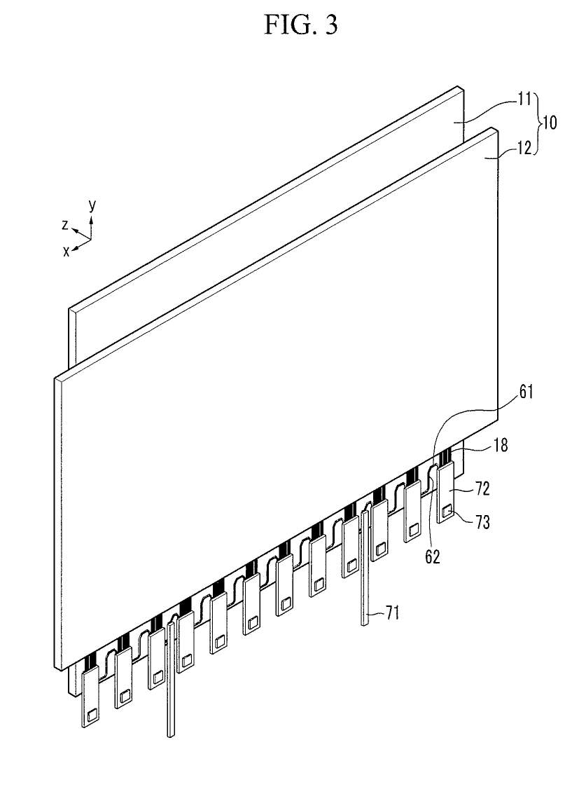

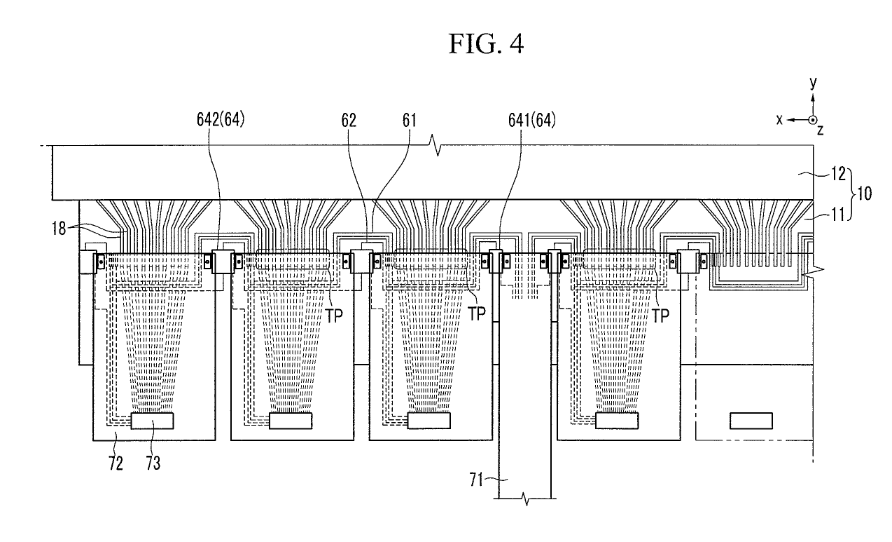

Therefore, the exemplary embodiment of the present invention including the address buffer board assembly, smoothly controls the address electrodes 13. For this purpose, the PDP 10 includes signal lines 61 and a power line 62 formed on the edge thereof and connected thereto. An interface FPC 71 connects the integrated board assembly 43 to the signal lines 61 and the power line 62 (referring to FIG. 3 and FIG. 4). Further, the interface FPC 71 may be connected to the integrated board assembly 43 by a connector (not shown) or may be connected directly by heat compression, or may be connected directly to the signal lines 61 and the power line 62.

FIG. 3 is a perspective view of the PDP shown in FIG. 1 from the front side, and FIG. 4 is a top plan view showing the signal lines and a power line that are formed on an edge of a PDP of FIG. 3 and connected to a FPC and an interface FPC. Referring to FIG. 3 and FIG. 4, the signal lines 61 and the power line 62 are formed in a non-display region of the PDP 10, that is, the signal lines 61 and the power line 62 are formed on the edge of the rear substrate 11.

The signal lines 61, the power line 62, and the interface FPC 71 are capable of electrically connecting the integrated board assembly 43 to the address electrodes 13. Also, a driver integrated circuit (IC) 73 is mounted to a tape carrier package (TCP) 72, of which one side thereof is connected to the signal lines 61 and the power line 62, and the other side thereof is connected to the address electrodes 13. Concretely, the TCP 72 is connected to electrode terminals 18 such that the TCP 72 is connected to the address electrodes 13.

Accordingly, the interface FPC 71 applies the control signal and the power of the integrated board assembly 43 to the signal lines 61 and the power line 62. The TCP 72 applies the control signal and the power applied to the signal lines 61 and the power line 62 to the driver IC 73, and selectively applies the control signals and the address voltage generated in the driver IC 73 to the address electrodes 13. As described above, the address electrodes 13 may be controlled by the integrated board assembly 43 and the driver IC 73.

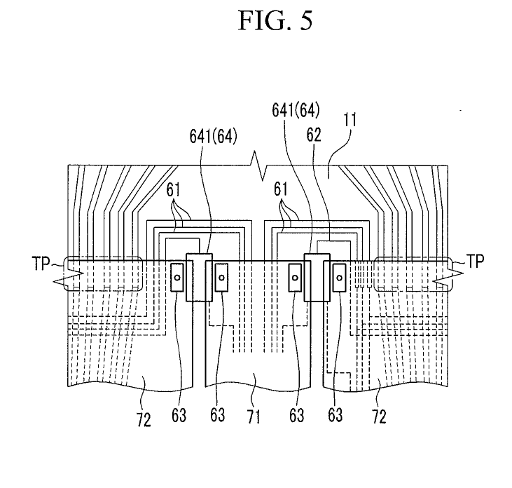

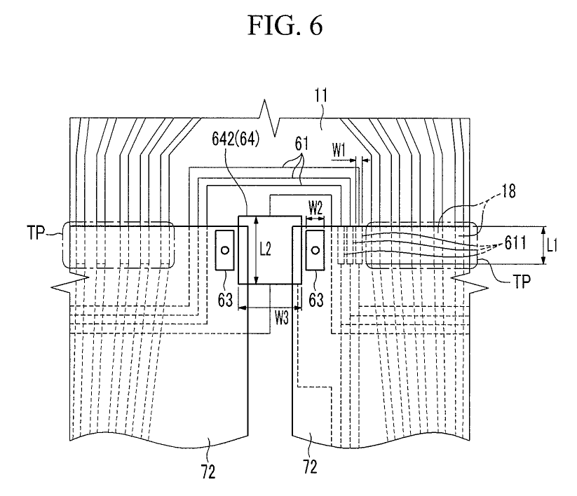

The structure in which the interface FPC 71 is connected to the signal lines 61 and the power line 62, and the TCP 72 is connected to the signal lines 61, the power line 62, and the electrode terminals 18 of the address electrode 13, will be described with reference to FIG. 5 and FIG. 6.

Referring to FIG. 6, the PDP 10 includes signal line terminals 611, alignment marks 63 and a power terminal 64 that are connected to the electrode terminals 18, and the signal lines 61. The power terminal 64 is electrically connected to the power line 62, thereby applying the power supplied from the power line 62 to the TCP 72 and the driver IC 73. The power that is supplied to the power line 62 and the power terminal 64 is controlled as the address voltage in the driver IC 73 and the TCP 72, and is applied to the address electrode 13.

The power line 62 supplies the power that will be supplied as the address voltage, such that power of a higher voltage than the operation voltage of the driver IC 73, the control signal of the driver IC 73, a clock signal, and the address data signal of the signal line 61 is applied. Accordingly, it is necessary that the impedance of the power line 62 is reduced.

FIG. 5 is a top plan view showing an arrangement of signal lines 61, a power line 62, alignment marks 63, and a power terminal 64, and a connection state of the interface FPC 71 of FIG. 4. FIG. 5 shows fastening of the interface flexible printed circuit (IFPC) 71.

FIG. 6 is a top plan view showing an arrangement of signal lines 61, a power line 62, electrode terminals 18, alignment marks 63, and a power terminal 64, and a connection state of an interface flexible printed circuit (IFPC) 70 of FIG. 4. FIG. 6 shows fastening of the TCP 72 including the driver IC 73.

Referring to FIG. 5 and FIG. 6, the electrode terminals 18 are connected to the TCPs 72 thereby forming various terminal groups TP. The various terminal groups TP are disposed in the x-axis direction at the edge of the rear substrate 11. The power terminal 64 is integrally formed between neighboring pairs of terminal groups TP. Also, the alignment marks 63 are respectively formed on both sides of the terminal groups TP.

Referring to FIG. 4, the power terminal 64 includes first and second power terminals 641 and 642 that are divided by the presence of the interface FPC 71.

Referring to FIG. 5, the first power terminal 641 respectively connects the interface FPC 71 and the TCP 72 at both sides in the x-axis direction.

If the first power terminal 641 on one side of the x-axis direction the first power terminal 641 is disposed between the interface FPC 71 and the TCP 72. Accordingly, the alignment marks 63 are respectively disposed on both sides of the first power terminal 641, and help align the FPC 71 and the TCP 72, when adhering these elements to the first power terminal 64. One of the alignment marks 63 is disposed at one side of the first power terminal 641 and is attached to the interface FPC 71, while the other alignment mark 63 is disposed at the other side of the first power terminal 64 and is attached to the TCP 72.

Accordingly, the power is applied to the TCP 72 through the interface FPC 71, the power line 62, and the first power terminal 641. That is, one side of the first power terminal 641 reduces the impedance of the interface FPC 71, the power line 62, and therebetween, and the other side of the power terminal 641 reduces the impedance of the TCP 72, the power line 62, and therebetween.

Referring to FIG. 6, the second power terminal 642 connects one pair of TCPs 72, near each other, at both sides of the second power terminal 642 on the x-axis direction.

The second power terminal 642 is disposed between the neighboring TCPs 72. Accordingly, the alignment marks 63 are respectively disposed at both sides of the second power terminal 642, and when adhering the TCPs 72 to the second power terminal 642, the alignment marks 63 align the TCPs 72. One of the alignment marks 63 is disposed at one side of the second power terminal 642, while the other alignment mark 63 is disposed on the other side of the second power terminal 642 and is adhered to the other TCP 72. Also, one side of the second power terminal 642 is connected to the TCP 72 of one side, and the other side thereof is connected to the TCP 72 of the other side.

Accordingly, the power is applied to the TCP 72 through the power line 62 and the second power terminal 642. That is, both sides of the second power terminal 642 reduce the impedance of the power line 62, the TCP 72, and therebetween.

On the other hand, the electrode terminals 18, the signal line terminals 611, and the alignment mark 63 extend in the y-axis direction at the edge of the rear substrate 11, and may have the first length L1, which is the same for all. The power terminal 64, on the other hand, has a second length L2 that is longer than the first length L1.

Also, the electrode terminals 18 and the signal line terminals 611 have the same width in the x-axis direction, that is, the first width W1. On the other hand, the alignment marks 63 have a second width W2 that is wider than the first width W1 such that the interface FPCs 71 and TCPs 72 can be easily aligned.

The power terminal 64 may have a third width W3 that is wider than the first and second widths W1 and W2. Also, among the power terminals 64, the first power terminal 641 may have the same width as that of the second power terminal 642, or may be formed with a lesser width than that of the second power terminal 642. For example, the last width W of the first power terminal 641 may be smaller than the last width W of the second power terminal 642. This because two first power terminals 641 are formed, and one second power terminal 642 is formed between the neighboring TCPs 72.

As described above, the power terminal 64 that is disposed on the power line 62 and is connected to the interface FPC 71 or the TCP 72 has a wider area than that of the electrode terminals 18 and the signal line terminals 611 such that the power of the high voltage may be applied, and the impedance of the power line 62 and the power terminal 64 may be reduced.

Again, referring to FIG. 2, the TCP 72 connected to the signal lines 61 and the power line 62 is connected to the electrode terminals 18, which in turn are connected to the address electrodes 13 such that the address voltage and the control signals generated in the driver IC 73 are applied to the address electrodes 13. A sealing member 50 seals the signal lines 61, the power line 62, the connection of the FPC 71 of them, and the connection of the TCP 72, thereby protecting them from the external environment.

On the other hand, the driver IC 73 mounted in the TCP 72 includes a heat dissipation pad 74 being supported by a cover plate 75, or thermal grease (not shown). The cover plate 75 is mounted on a bent portion 33 of the chassis base 30 by the setscrew 32, thereby protecting the TCP 72.

Another exemplary embodiment of the present invention will be described, and descriptions of the same elements discussed above are omitted, and therefore only different elements will be described

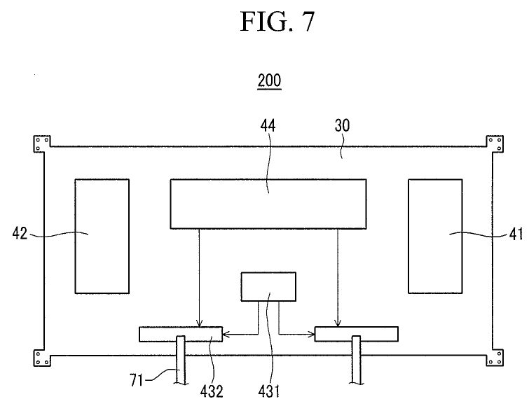

FIG. 7 is a rear view of a chassis base of a plasma display device according to another exemplary embodiment of the present invention. Referring to FIG. 7, the plasma display device 200 includes a mini-board assembly 432, thereby reducing the elements of the address buffer board assembly.

That is, the elements of the conventional address buffer board assembly are formed at a logic board assembly 431, and at the mini-board assembly 432, signal lines 61, a power line 62, and a power terminal 64.

Among the address voltage and the control signals controlling the address electrode 13, the address voltage that is a relatively high voltage is used as the power that is applied from the power supply board assembly 44 to the mini-board assembly 432. Accordingly, the address voltage that is controlled through the mini-board assembly 432, the interface flexible printed circuit (IFPC) 71, the power line 62, the power terminal 64, and the TCP 72 is applied to the address electrode 13.

As a relative low voltage, a ground of the driver IC 73, the driving voltage Vcc of the driver IC 73, the drive IC control signal, the clock signal, and the address data signal are applied to the mini-board assembly 432 from the logic board assembly 431. Accordingly, the control signals of the low voltage are applied to the TCP 72 and the driver IC 73 through the interface FPC 71 and the signal lines 61 in the mini-board assembly 432.

Similarly to the to other embodiment of the present invention, in this exemplary embodiment which includes the mini-board assembly 432, the functions of the conventional address buffer board assembly are reduced. However, the signal lines 61, the power line 62, and the power terminal 64 are equally provided on the edge of the PDP 10 such that the impedance may be reduced in the power line 62 and in the power terminal 64.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plasma display panel (PDP) including a plurality of electrodes;
a printed circuit board assembly (PBA) to drive the plasma display panel (PDP); and
a chassis base including a first surface supporting the plasma display panel (PDP) and a second surface mounted with the printed circuit board assembly (PBA),
wherein the PDP includes
signal lines and a power line continuously formed on an edge of the PDP,
electrode terminals connected to the plurality of electrodes, to the signal lines and to the power line,
signal line terminals disposed on one side of the electrode terminals and connected to the signal lines,
an alignment mark formed on at least at one side of the signal line terminals, and
a power terminal disposed on a side of the at least one alignment mark and being connected to the power line and supplying power to the PDP.

2. The plasma display device of claim 1, further comprising:
an interface flexible printed circuit (IFPC) having one side connected to the PBA, and another side connected to the signal lines and the power line; and
a flexible printed circuit (FPC) including a driver IC mounted thereon and being connected to the signal line terminals and the power terminal on one side, and being connected to the electrode terminals on the other side.

3. The plasma display device of claim 2, wherein
the electrode terminals connected to the flexible printed circuit (FPC) form a terminal group, and several terminal groups are disposed in a first direction, and
the power terminal is integrally formed between neighboring pairs of terminal groups.

4. The plasma display device of claim 3, wherein the at least one alignment mark is formed on both sides of the terminal group.

5. The plasma display device of claim 3, wherein the electrode terminals, the signal line terminals, and the at least one alignment mark extend in a second direction intersecting the first direction and have a same length along the second direction.

6. The plasma display device of claim 5, wherein the power terminal extends in the second direction and the power terminal is longer than the electrode terminals, the signal line terminals, and the at least one alignment mark.

7. The plasma display device of claim 6, wherein the power terminal extends in a first direction and the power terminal is wider than the electrode terminals, the signal line terminals, and the alignment mark.

8. A plasma display device comprising:
a plasma display panel (PDP) including a front substrate, a rear substrate, a plurality of electrodes between the front substrate and the rear substrate, and signal lines, a power line, electrode terminals, signal line terminals, an alignment mark, and a power terminal separated from the plurality of electrodes and formed at the rear substrate;
a chassis base close to the rear substrate; and
a plurality of printed circuit board assemblies (PBAs) mounted to the chassis base,
wherein the signal lines and the power line are continuously formed on an edge of the PDP,
the electrode terminals are connected to the electrodes, the signal lines and the power line,
the signal line terminals are disposed on one side of the electrode terminals and connected to the signal lines,
the alignment mark is formed on at least one side of the signal line terminals, and
the power terminal is disposed on sides of the at least one alignment mark thereby being connected to one side of the power line and supplying power to the PDP.

9. The plasma display device of claim 8, further comprising:
an interface flexible printed circuit (IFPC) having one side connected to the PBA, and another side connected to the signal lines and the power line; and
a flexible printed circuit (FPC) including a driver IC mounted thereon, and having one side connected to the signal line terminals and the power terminal, and having another side connected to the electrode terminals.

10. The plasma display device of claim 9, wherein:
the electrode terminals connected to the flexible printed circuit (FPC) form a terminal group;
and several terminal groups are disposed in a first direction;
the at least one alignment mark is formed on both sides of the terminal group, and
the power terminal is integrally formed between neighboring alignment marks.

11. The plasma display device of claim 10, wherein
the electrode terminals, the signal line terminal, and the alignment mark extend in a second direction intersecting the first direction and have a first length, and
the power terminal has a second length longer than the first length.

12. The plasma display device of claim 11, wherein the electrode terminals and the signal line terminals have a first width with respect to the first direction, the alignment mark has a second width wider than the first width with respect to the first direction, and the power terminal has a third width wider than the second width with respect to the first direction.

13. The plasma display device of claim 9, wherein the power terminal has a first power terminal connecting the interface flexible printed circuit (IFPC) and the flexible printed circuit (FPC).

14. The plasma display device of claim 13, wherein the power terminal has a second power terminal respectively connecting one pair of flexible printed circuits (FPCs).
